(19) United States
(12) Patent Application Publication
(10) Pub. No.: US 2026/0365129 A1
(43) Pub. Date: Nov. 19, 2026

(54) VEHICLE SYSTEM, CONTROL METHOD OF VEHICLE SYSTEM, AND ELECTRONIC CONTROL UNIT

(71) Applicant: DENSO CORPORATION, Kariya-city (JP)

(72) Inventors: Sho MATSUMOTO, Kariya-shi (JP); Tomohisa KISHIGAMI, Kariya-shi (JP)

(21) Appl. No.: 19/654,924

(22) Filed: Apr. 22, 2026

(30) Foreign Application Priority Data
May 15, 2025 (JP) 2025-082169

(51) Int. Cl. B60R 16/023; H02J 1/14; H04L 12/12; H04L 12/40

(52) U.S. Cl. CPC B60R 16/0231; B60R 16/0238; H02J 1/14; H04L 12/12; H04L 12/40039; H04L 2012/40215; H04L 2012/40273

(57) ABSTRACT

In a vehicle system, a high-level side control device includes a relay controller that turns ON and OFF a relay circuit provided in a power supply line for a low-level control device. The low-level control device retains cluster configuration information indicative of a cluster to which the low-level control device belongs among multiple clusters and switches over between a sleep state and an activated state based on a network management message. The relay controller controls ON and OFF of the relay circuit depending on whether an operating mode of the vehicle system is a power-saving oriented mode or a responsiveness-oriented mode.

### CROSS-REFERENCE TO RELATED APPLICATION

This application is based on Japanese Patent Application No. 2025-082169 filed in Japan on May 15, 2025. The entire disclosure of the above application is incorporated herein by reference.

### TECHNICAL FIELD

The present disclosure relates to a vehicle system including a plurality of control devices mounted on a vehicle, a control method of a vehicle system, and an electronic control unit used in a vehicle system.

### BACKGROUND

For example, there is such a technology that an in-vehicle device cuts off supply of power from a power supply device to an in-vehicle ECU not required to be activated. The technology activates only an activation-target in-vehicle ECU and avoids activating an in-vehicle ECU not required to be activated.

### SUMMARY

In a vehicle system, a high-level side control device includes a relay controller that turns ON and OFF a relay circuit provided in a power supply line for a low-level control device. The low-level control device retains cluster configuration information indicative of a cluster to which the low-level control device belongs among multiple clusters and switches over between a sleep state and an activated state based on a network management message. The relay controller controls ON and OFF of the relay circuit depending on whether an operating mode of the vehicle system is a power-saving oriented mode or a responsiveness-oriented mode.

### BRIEF DESCRIPTION OF THE DRAWINGS

Objects, features and advantages of the present disclosure will become apparent from the following detailed description made with reference to the accompanying drawings. In the drawings:

FIG. 1 is a diagram showing an example of a configuration when a vehicle system according to a first embodiment is applied to a smart-entry/smart-start system for a vehicle;

FIG. 2 is a diagram showing an example of a configuration of a vehicle system according to the first embodiment;

FIG. 3 is a diagram showing examples of an NM message, PN request information, and PNC configuration information;

FIG. 4 is a flowchart showing an example of a process executed by a high-level ECU;

FIG. 5 is a flowchart showing an example of a process executed by an intermediate-level ECU;

FIG. 6 is a flowchart showing an example of a process executed by a low-level ECU;

FIG. 7 is a flowchart showing an example of a process executed by an intermediate-level ECU in a vehicle system according to a second embodiment; and

FIG. 8 is a diagram showing an example of a configuration of a vehicle system according to a third embodiment.

### DETAILED DESCRIPTION

For example, there is such a technology that an in-vehicle device cuts off supply of power from a power supply device to an in-vehicle ECU not required to be activated. The in-vehicle device is communicably connected to multiple in-vehicle ECUs. The in-vehicle device acquires information on an activation target in-vehicle ECU via an in-vehicle network. Then, the in-vehicle device supplies power to the activation target in-vehicle ECU and outputs an activation signal via the in-vehicle network while cutting off the supply of power to an in-vehicle ECU not required to be activated. This results in activating only the activation target in-vehicle ECU by the activation signal and avoiding activating the in-vehicle ECU not required to be activated.

The in-vehicle device supplies the power to the in-vehicle ECU required to be activated and cuts off the supply of power to the in-vehicle ECU not required to be activated. Therefore, it is possible to prevent a dark current from flowing to the in-vehicle ECU not required to be activated. As a result, a significant power reduction effect can be achieved concerning the power consumed by respective in-vehicle ECUs.

The in-vehicle device supplies the power to the activation target in-vehicle ECU in response to acquiring information on the activation target in-vehicle ECU. In the activation target in-vehicle ECU, the supply of power causes execution of a boot process and the ECU enters into a state of being able to receive an activation signal. This causes such an issue that it takes a relatively long time for the in-vehicle device to activate the activation target in-vehicle ECU by the activation signal.

In view of the foregoing, it is an object of the present disclosure to provide a vehicle system, a control method of a vehicle system, and an electronic control unit used in a vehicle system that can achieve both power saving and reduction in activation time of a control device in a vehicle.

According to a first aspect of the present disclosure, a vehicle system comprising a plurality of control devices mounted on a vehicle is provided. The plurality of control devices includes at least one low-level control device and at least one high-level side control device. The high-level side control device includes a relay controller that turns ON and OFF a relay circuit provided in a power supply line for the low-level control device. The low-level control device retains cluster configuration information indicative of a cluster to which the low-level control device belongs among a plurality of clusters being divisions and switches over between a sleep state and an activated state depending on presence and absence of receipt of a network management message that designates the cluster to which the low-level control device belongs as an active cluster. A control device being any of the plurality of control devices determines whether an operating mode of the vehicle system is a power-saving oriented mode in which emphasis is placed on power saving of the vehicle system or a responsiveness-oriented mode in which emphasis is placed on responsiveness of processing of the vehicle system. Where the control device determines that the operating mode of the vehicle system is the power-saving oriented mode, if the low-level control device is to stop operating, the relay controller of the high-level side control device turns OFF the relay circuit and stops supply of power to the low-level control device. Where the control device determines that the operating mode of the vehicle system is the responsiveness-oriented mode, if the low-level control device is to stop operating, the relay controller of the high-level side control device keeps an ON state of the relay circuit to enable the low-level control device to switch over to the sleep state based on the network management message.

According to a second aspect of the present disclosure, a control method of a vehicle system is provided. The vehicle system includes a plurality of control devices mounted on a vehicle. The plurality of control devices includes at least one low-level control device and at least one high-level side control device. The high-level side control device includes a relay controller that turns ON or OFF a relay circuit provided in a power supply line for the low-level control device. The low-level control device retains cluster configuration information indicative of a cluster to which the low-level control device belongs among a plurality of clusters being divisions and switches over between a sleep state and an active state depending on presence and absence of receipt of a network management message that designates the cluster to which the low-level control device belongs as an active cluster. The control method comprises: by a control device being any of the plurality of control device, determining whether an operating mode of the vehicle system is a power-saving oriented mode in which emphasis is placed on power saving of the vehicle system or a responsiveness-oriented mode in which emphasis is placed on responsiveness of processing of the vehicle system; where the control device determines that the operating mode of the vehicle system is the power-saving oriented mode, if the low-level control device is to stop operating, by the relay controller of the high-level side control device, turning OFF the relay circuit and stopping supply of power to the low-level control device; and where the control device determines that the operating mode of the vehicle system is the responsiveness-oriented mode, if the low-level control device is to stop operating, by the relay controller of the high-level side control device, keeping an ON state of the relay circuit to enable the low-level control device to switch over to the sleep state based on the network management message.

According to a third aspect of the present disclosure, an electronic control unit that is in a vehicle system including at least one low-level control device and at least one high-level side control device and that is used as the high-level side control device is provided. The low-level control device retains cluster configuration information indicative of a cluster to which the low-level control device belongs among a plurality of clusters being divisions and switches over between a sleep state and an active state depending on presence and absence of receipt of a network management message that designates the cluster to which the low-level control device belongs as an active cluster. The vehicle system has a power-saving oriented mode and a responsiveness-oriented mode as an operating mode thereof. The high-level side control device comprises a relay controller that turns ON and OFF a relay circuit provided in a power supply line for the low-level control device. Where the operating mode of the vehicle system is the power-saving oriented mode, if the low-level control device is to stop operating, the relay controller of the high-level side control device turns OFF the relay circuit and stops supply of power to the low-level control device. Where the operating mode of the vehicle system is the responsiveness-oriented mode, if the low-level control device is to stop operating, the relay controller of the high-level side control device keeps an ON state of the relay circuit to enable the low-level control device to switch over to the sleep state based on the network management message.

According to the vehicle system, the control method of the vehicle system, and the electronic control unit used in the vehicle system of the present disclosure described above, where the operating mode of the vehicle system is the power-saving oriented mode, if the low-level control device is to stop operating, the relay controller of the high-level side control device turns OFF the relay circuit and stops supply of power to the low-level control device. On the other hand, where the operating mode of the vehicle system is the responsiveness-oriented mode, the relay controller of the high-level side control device keeps an ON state of the relay circuit. As a result, if the low-level control device is to stop operating, it is possible to switch over the low-level control device to the sleep state based on the network management message.

As described, where the operating mode of the vehicle system is the power-saving oriented mode, if the low-level control device is to stop operating, the high-level side control device stops supply of power to the low-level control device. Therefore, it is possible to achieve power saving of the vehicle system. On the other hand, where the operating mode of the vehicle system is the responsiveness-oriented mode, even if the low-level control device is to stop operating, the high-level side control device keeps supplying the power to the low-level control device. In this case, the low-level control device can switch over to the sleep mode based on the network management message. Therefore, because the low-level control device can activate from the sleep state in response to a command to activate by the network management message, it is possible to achieve reduction in activation time of the low-level control device.

Hereinafter, embodiments of a vehicle system and a control method of the vehicle system according to the present disclosure will be described with reference to the drawings. However, the present disclosure is not limited to the following embodiments, and various modifications including those described below are also included in the technical scope of the present disclosure. In addition, other various modifications can be made without departing from the spirit and scope of the present disclosure. Embodiments and various modification examples are combinable as appropriate to extents that do not cause technical contradiction. In the following description and the drawings, like references are used to refer to like parts, so that the redundant description may be omitted. When only part of the configuration is described, the description given elsewhere can be applied to the rest of the configuration.

### First Embodiment

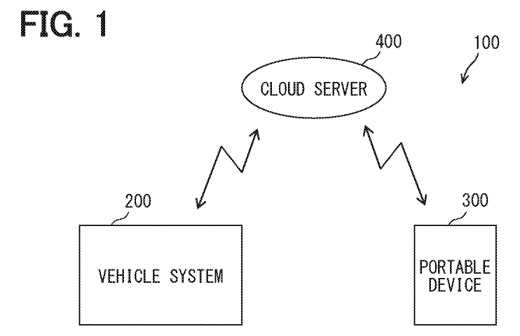

FIG. 1 shows a configuration when a vehicle system 200 of the present embodiment is applied to a smart-entry/smart-start system 100 for a vehicle. The smart-entry/smart-start system 100 includes a vehicle system 200, a portable device 300 carried by a user, and a cloud server 400. However, if, for example, the vehicle system 200 and the portable device 300 transmit and receive various data via wireless communication, such as Bluetooth (registered trademark) communication, without going through the cloud server 400, the cloud server 400 may be omitted.

The vehicle system 200 executes wireless communication with the portable device 300 to determine whether or not the portable device 300 has privileges as an authorized vehicle key by, for example, checking an identifier of the portable device 300. Upon determining that the portable device 300 has privileges as an authorized vehicle key, the vehicle system 200 executes controls such as locking and unlocking a vehicle door (smart entry function) and starting an engine (smart start function).

The portable device 300 is configured to be able to issue a command as to whether the operating mode of the vehicle system 200 should be a power-saving oriented mode in which emphasis is placed on power saving of the vehicle system 200 or a responsiveness-oriented mode in which emphasis is placed on responsiveness of processing of the vehicle system 200. For example, if the portable device 300 is a portable information terminal such as a smartphone, the user can select whether to set the power-saving-oriented mode or the responsiveness-oriented mode by using an application implemented in the portable information terminal.

In this case, the user logs into the application by entering, for example, a pre-registered user ID and a password. On the application, the user then makes a selection between the power-saving oriented mode and the responsiveness-oriented mod. The user's selection of the operating mode is then transmitted from the portable device 300 to the vehicle system 200 via the cloud server 400. The vehicle system 200 can set the operating mode of the vehicle system 200 based on the receipt of the command as to the user selection of the operating mode. The operating mode of the vehicle system 200 will be described in detail later.

Alternatively, the user selection of the operating mode of the vehicle system 200 (either the power-saving oriented mode or the responsiveness-oriented mode) may be made, for example, by a touch operation to a multimedia screen installed in the vehicle cabin or by an operation to a dedicated physical switch on the dashboard.

Without relying on the user selection and command, the selecting and setting of the operating mode of the vehicle system 200 may be automatically made according to the situation of the vehicle. For example, if any ECU in the vehicle system 200 (e.g., a high-level ECU 10 described below) determines that the vehicle system 200 is placed in a situation where it is considered that the vehicle system is unlikely used, the ECU may determine that the operating mode of the vehicle system 200 should be the power-saving oriented mode and may set the operating mode of the vehicle system 200 to the power-saving oriented mode.

The situation in which it is considered that the vehicle system 200 is unlikely used may be, for example, a situation in which a period of time during the user is absent in or around the vehicle reaches a given time or more. Whether the user is in or around the vehicle may be detected via wireless communication between the vehicle system 200 and the portable device 300.

Alternatively, the situation in which it is considered that the vehicle system 200 is unlikely used may be a situation in which the vehicle is parked in a given area. For example, the given area may be an airport parking lot, a shopping mall parking lot, a yard before sea shipping, a home parking lot, a workplace parking lot, etc., where the vehicles may be parked for a long period of time. Whether or not the vehicle is located within the given area may be determined based on, for example, the location of the vehicle as identified by a locater device such as a GPS device installed in the vehicle, or the presence or absence of communication with a beacon or Wi-Fi (registered trademark) that is communicable with the vehicle within the given area.

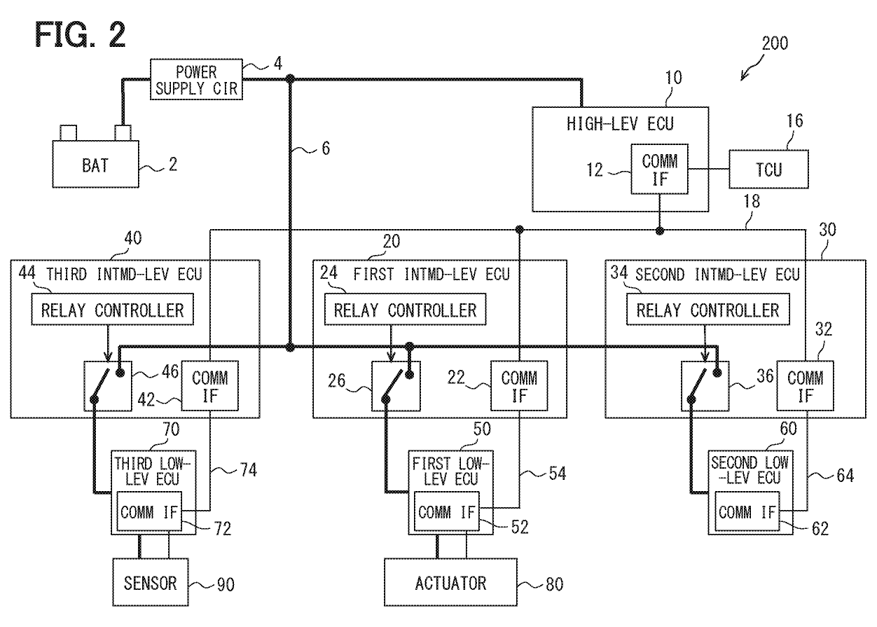

As shown in FIG. 2, the vehicle system 200 includes a plurality of electronic control units (hereinafter referred to as ECU) 10, 20, 30, 40, 50, 60, 70, an actuator 80 that operates as commanded by the first low-level ECU 50, and a sensor 90 that provides a sensor signal to the third low-level ECU 70.

The plurality of ECUs 10, 20, 30, 40, 50, 60, 70 of the vehicle system 200 include a high-level ECU 10, first to third intermediate-level ECUs 20, 30, 40, and first to third low-level ECUs 50, 60, 70. The first to third intermediate-level ECUs 20, 30, 40 correspond to high-level side control devices of the present disclosure. The first to third low-level ECUs 50, 60, 70 correspond to low-level control devices of the present disclosure. The high-level ECU 10, the first to third intermediate-level ECUs 20, 30, 40, and the first to third low-level ECUs 50, 60, 70 include communication interfaces (I/F) 12, 22, 32, 42, 52, 62, 72, respectively. The communication IFs 12, 22, 32, 42, 52, 62, 72 are connected to via communication buses 18, 54, 64, 74. This allows the high-level ECU 10, the first to third intermediate-level ECUs 20, 30, 40, and the first to third low-level ECUs 50, 60, 70 to communicate with each other.

The vehicle system 200 may use CAN as a communication protocol for the high-level ECU 10, the first to third intermediate-level ECUs 20, 30, 40, and the first to third low-level ECUs 50, 60, 70 to communicate with each other. CAN is an abbreviation for Controller Area Network. It should be noted that the communication protocol is not limited to CAN. The in-vehicle system 200 may adopt various communication protocols such as Ethernet (registered trademark), LIN (Local Interconnect Network), FlexRay (registered trademark), and CAN-FD (CAN with Flexible Data Rate). For example, different communication protocols may be adopted for different communication buses 18, 54, 64, 74.

The high-level ECU 10, the first to third intermediate-level ECUs 20, 30, 40, the first to third low-level ECUs 50, 60, 70, the actuator 80, and the sensor 90, which constitute the vehicle system 200, are mounted on the vehicle. The vehicle encompasses a passenger car, a motorcycle, a transport vehicle, a construction vehicle, an agricultural vehicle, and the like.

The vehicle system 200 operates with power supplied from a battery 2 mounted on the vehicle. More specifically, the power from the battery 2 is provided via a power supply circuit 4 to the high-level ECU 10, the first to third intermediate-level ECUs 20, 30, 40, the first to third low-level ECUs 50, 60, 70, the actuator 80, and the sensor 90 of the vehicle system 200. The power circuit 4 is able to convert a power supply voltage of the battery 2 in the vehicle into an operating voltage of the high-level ECU 10, the first to third intermediate-level ECUs 20, 30, 40, the first to third low-level ECUs 50, 60, 70, the actuator 80, and the sensor 90, on an as needed basis.

First to third relay circuits 26, 36, 46 are provided in power supply lines 6 to the first to third low-level ECUs 50, 60, 70. The first to third relay circuits 26, 36, 46 are switched over between an ON state and an OFF state by the relay controllers 24, 34, 44 of the first to third intermediate-level ECUs 20, 30, 40.

The first to third relay circuits 26, 36, 46 may be provided by semiconductor switches, such as metal oxide semiconductor field effect transistors (MOSFET) or insulated gate bipolar transistors (IGBT). Alternatively, the first to third relay circuit 26, 36, 46 may be provided by a normal mechanical relay instead of the semiconductor switch. The first to third relay circuits 26, 36, 46 may be located inside the first to third intermediate-level ECUs 20, 30, 40 as shown in FIG. 2, or outside the first to third intermediate-level ECUs 20, 30, 40.

The configuration of the vehicle system 200 is not limited to the example shown in FIG. 2. For example, the number of high-level ECUs 10 may be two or more instead of one. In this case, the intermediate-level ECU and the low-level ECU may be arranged below each high-level ECU. The two or more high-level ECUs may be communicably connected to each other. Any of the intermediate-level ECUs 20, 30, 40 may be configured to perform the functions of high-level ECU 10, and in this case, the high-level ECU 10 may be omitted. The number of intermediate-level ECUs 20, 30, 40 arranged below the high-level ECU 10 may be other than three, that is, may be two or less, or four or more. Regarding the low-level ECUs 50, 60, 70, two or more low-level ECUs may be connected to one relay circuit 26, 36, 46. The low-level ECUs 50, 60, 70 may include a low-level ECU to which the power is supplied directly from the power supply circuit 4 without going through the relay circuits 26, 36, 46. An actuator and a sensor may be arranged for each low-level ECU 50, 60, 70. The actuator 80 and/or the sensor 90 may include an actuator and/or a sensor to which the power is supplied directly from the power supply circuit 4 without going through the relay circuit 26, 46.

The high-level ECU 10 determines whether the operating mode of the vehicle system 200 should be the power-saving oriented mode or the responsiveness-oriented mode and sets the operating mode to the determined mode. Specifically, the high-level ECU 10 is configured to receive the command from the portable device 300 as to the selection of the operating mode of the vehicle system 200 via a telematics control unit (TCU) 16 communicable with the cloud server 400. Alternatively, the high-level ECU 10 may receive the command as to the selection of the operating mode of the vehicle system 200 via the second low-level ECU 60, wherein the second low-level ECU 60 is configured to display the multimedia screen and detect the touch operation to the multimedia screen. Furthermore, the high-level ECU 10 may be configured to determine whether a situation has occurred in which it is considered that the vehicle system 200 is unlikely used, and based on a result of the determination, determine that the operating mode of the vehicle system 200 should be the power-saving oriented mode.

When the high-level ECU 10 receives the command to set the operating mode of the vehicle system 200 to the power-saving oriented mode, or when the high-level ECU 10 determines, based on the situation of the vehicle, that the operating mode of the vehicle system 200 should be the power-saving oriented mode, the high-level ECU 10 notifies the first to third intermediate-level ECUs 20, 30, 40 of the vehicle system 200 that the operating mode of the vehicle system 200 is the power-saving oriented mode. On the other hand, if the high-level ECU 10 receives the command to set the operating mode of the vehicle system 200 to the responsiveness-oriented mode, or if the high-level ECU 10 determines that the operating mode of the vehicle system 200 should not be the power-saving oriented mode based on the situation of the vehicle, the high-level ECU 10 notifies the first to third intermediate-level ECUs 30, 40, 50 that the operating mode of the vehicle system 200 is the responsiveness-oriented mode.

The function of determining whether the operating mode of the vehicle system 200 should be the power-saving-oriented mode or the responsiveness-oriented mode may be provided not in the high-level ECU 10, but in any of the first to third intermediate-level ECUs 20, 30, 40 or any of the first to third low-level ECUs 50, 60, 70, for example.

In addition, the high-level ECU 10 may be configured to determine that the situation requires the low-level ECU 50, 60, 70 to be activated and operate by, for example, and transmit a network management (hereinafter referred to as NM) message to activate the corresponding low-level ECU and put the corresponding low-level ECU into an operational state. The NM message will be described in detail later.

The functions of determining that the situation requires the low-level ECU 50, 60, or 70 to be activated and operate and transmitting the NM message to activate the corresponding low-level ECU may be provided in the first or third intermediate-level ECUs 20, 30, 40, in addition to or in place of the high-level ECU 10. When the vehicle includes multiple high-level ECUs and multiple intermediate-level ECUs arranged below a respective high-level ECU, the NM message for activating the low-level ECU may be transmitted from another high-level ECU or an intermediate-level ECU arranged below another high-level ECU.

The first to third intermediate-level ECUs 20, 30, 40, respectively, include the first to third relay controller 24, 34, and 44 for controlling turn ON and OFF of the relay circuits 26, 36, and 46, as described above. Where the operating mode of the vehicle system 200 is the power-saving oriented mode, if it is determined based on the NM message that the low-level ECU 50, 60, 70 is requested to be activated, the first to third relay controller 24, 34, 44 turns ON the corresponding relay circuit. Where the operating mode of the vehicle system 200 is the power-saving oriented mode, if it is determined based on the NM message that the low-level ECU 50, 60, 70 is requested to stop operating, the first to third relay controller 24, 34, and 44 turns OFF the corresponding relay circuit. Where the operating mode of the vehicle system 200 is the power-saving oriented mode, if it is determined based on the NM message that the low-level ECUs 50, 60, 70 is requested to be activated, the first to third relay controller 24, 34, and 44 issues a command to turn ON the corresponding relay circuit.

Where the operating mode of the vehicle system 200 is the power-saving oriented mode, the first to third relay controller 24, 34, 44 do not perform ON OFF control of the relay circuit 26, 36, 46 based on the NM message. In this case, the first to third relay controller 24, 34, 44, in principle, keeps the ON state of the relay circuit 26, 36, 46 and keeps supplying the power to the first to third low-level ECU 50, 60, 70.

In addition to the function of turning ON and OFF a respective relay circuit 26, 36, 46, the first and third intermediate-level ECU 20, 30, 40 serves as a relay device (in other words, a gateway) for two-way communication between ECUs connected to different communication buses 18, 54, 64, 74. For example, the first to third intermediate-level ECU 20, 30, 40 relays (in words, gateway) the NM message received from one communication bus 18, 54, 64, 74 to another communication bus 18, 54, 64, 74. A control message containing data on control or the like, other than the NM message for achieving partial networking, is transmitted and received between the first and third low-level ECUs 50, 60, 70. The first to third intermediate-level ECU 20, 30, 40 also functions as a gateway for such control messages. This enables smooth execution of coordinated control by multiple low-level ECUs 50, 60, 70 belonging to the same cluster. The cluster will be described in detail later.

A respective first to third low-level ECU 50, 60, 70 retains cluster configuration information (also called PNC configuration information) indicative of a cluster to which the respective first to third low-level ECU 50, 60, 70 belongs among multiple clusters being multiple divisions. A respective first to third low-level ECU 50, 60, 70 has a partial networking compatible function able to switch over between a sleep state and an activated state (operational state) depending on presence and absence of receipt of the NM message that designates the cluster to which the respective first to third low-level ECU 50, 60, 70 belongs as an active cluster.

In the sleep state, the first to third low-level ECU 50, 60, 70 is able to determine whether the communication IF 52, 62, 72 thereof has received the NM message that designates the cluster to which the respective first to third low-level ECU 50, 60, 70 belongs as the active cluster. Alternatively, the first to third low-level ECU 50, 60, 70 having been activated in response to the receipt of the NM message may determine whether or not the cluster to which the respective first to third low-level ECU 50, 60, 70 belongs is designated as the active cluster in the received message. In this case, when a respective first to third low-level ECU 50, 60, 70 determines that the NM message that designates the cluster to which the respective first to third low-level ECU 50, 60, 70 belongs as the active cluster has not been received, the respective first to third low-level ECU 50, 60, 70 returns to the sleep state.

In the operational state, while a respective first to third low-level ECU 50, 60, 70 is executing a given control process, a calculation process on the detection signal from the sensors 90, or a driving process on the actuators 80, the respective first to third low-level ECU 50, 60, 70 transmits the NM message in which the cluster to which the respective first to third low-level ECU 50, 60, 70 belongs is designated as the active cluster. In the NM message, the information designating the active cluster is referred to as PN request information. Therefore, as long as at least one ECU in the operational state is in the group, a group of ECUs belonging to the same cluster is kept in the operational state. When a respective first to third low-level ECU 50, 60, 70 completes the control process, the calculation process, or the driving process, the respective first to third low-level ECUs 50, 60, 70 stops transmitting the NM message while keeping the activated state.

When a given period of time has elapsed since the first to third intermediate-level ECU 20, 30, 40 received the last NM message that contains the PN request information designating the cluster to which the first to third low-level ECU 50, 60, 70 belongs as the active cluster, in other words when the given period of time is reached by a period of time during which the first to third intermediate-level ECU 20, 30, 40 has not received the NM message containing the PN request information designating the cluster to which the first to third low-level ECU 50, 60, 70 belongs as the active cluster, the first to third intermediate-level ECU 20, 30, 40 determines that the first to third low-level ECU 50, 60, 70 should stop operating. Then the first to third intermediate-level ECU 20, 30, 40 turns OFF the relay circuit 26, 36, 46 corresponding to the low-level ECU 50, 60, 70 when the operating mode of the vehicle system 200 is the power-saving oriented mode. In the manner described above, where the operating mode of the vehicle system 200 is the power-saving oriented mode, if the first to third low-level ECU 50, 60, 70 is to stop operating, the first to third intermediate-level ECU 20, 30, 40 stops the supply of power to the first to third low-level ECU 50, 60, 70. Therefore, it is possible to achieve the power-saving of the vehicle system 200.

Where the operating mode of the vehicle system 200 is the responsiveness-oriented mode, the first to third intermediate-level ECU 20, 30, 40 does not execute ON OFF control of the relay circuit 26, 36, 46 based on the NM message, and in principle, keeps the ON of the relay circuit 26, 36, 46. In this case, a respective first to third low-level ECU 50, 60, 70 switches over between the activated state and the sleep state depending on presence and absence of receipt of the NM message by the partial networking compatible function thereof. Therefore, where the operating mode of the vehicle system 200 is the responsiveness-oriented mode, if the first to third low-level ECU 50, 60, 70 is to stop operating, the first to third low-level ECU 50, 60, 70 is switched over to the sleep state. Therefore, because the first to third low-level ECUs 50, 60, 70 in the sleep state activates upon being commanded to activate by the NM message, it is possible to reduce the activation time of the first to third low-level ECU 50, 60, 70.

The vehicle system 200 includes the actuator 80 which operates as commanded from the first low-level ECU 50 and the sensor 90 which provides the sensor signal to the third low-level ECU 70. In the configuration shown in FIG. 2, the power supply line and the communication bus for the actuator 80 are connected to the first low-level ECU 50. Therefore, as described below, when the first relay circuit 26 is turned OFF, the supply of power to the first low-level ECU 50 and the actuator 80 is stopped. The power supply line and the communication bus for the sensor 90 are connected to the third low-level ECU 70. Therefore, when the third relay circuit 46 is turned OFF, the supply of power to the third low-level ECU 70 and the sensor 90 is stopped.

The actuator 80 and the sensor 90 may each include a processing unit having a processing function capable of receiving a message according to the communication protocol described above and executing an operation according to a control command contained in the message and a processing function capable of, for example, based on the command from the high-level ECU 10, generating and transmitting a message containing information based on the detected sensor signal. In other words, the first low-level ECU 50 and the actuator 80 may be integrated to form so-called a smart actuator, or the third low-level ECU 70 and the sensor 90 may be integrated to form so-called a smart sensor.

In the smart-entry/smart-start system 100 for the vehicle, the actuator 80 may be, for example, a door lock motor that switches over the vehicle door between a locking state and an unlocking state. The sensor 90 may be a touch sensor that detects the user touch operation to the door handle of the vehicle door. In the configuration shown in FIG. 1, the third low-level ECU 70 is intermittently activated by the NM message and is able to detect the user touch operation with the sensor 90. When the third low-level ECU 70 detects the user touch operation with the sensor 90, the first low-level ECU 50 controls the operation of the door lock motor serving as the actuator 80. This allows the user to open the vehicle door and get into the vehicle.

The sensor 90 is not limited to the touch sensor but may be, for example, at least one communication device that performs wireless communication with the portable device 300 or the smart key carried by the user. The third low-level ECU 70 is intermittently activated by the NM messages and enables the wireless communication by the sensor 90. When the wireless communication between the sensor 90 and the portable device 300 or the smart key is performed, the third low-level ECU 70 may then check the identifier of the portable device 300 or calculate the distance to the portable device 300 from the vehicle and its position relative to the vehicle via the wireless communication. In this case, the first low-level ECU 50 may lock or unlock the vehicle door using the actuator 80 based on the distance from the vehicle to the portable device 300 or the smart key and its relative position to the vehicle.

The actuator 80 may be a starter motor for starting the engine, and the sensor 90 may be a switch sensor that detects an ON operation of a vehicle start switch. In this case, in response to the third low-level ECU 70 detecting the ON operation of the start switch with the sensor 90, the first low-level ECU 50 may drive the starter motor serving as the actuator 80 to start the engine. This allows the user to start the engine and drive the vehicle by operating the start switch.

Alternatively, the actuator 80 may be a fuel injector or an ignition device to drive the engine, and the sensor 90 may be an accelerator pedal sensor to detect a depressing amount of the accelerator pedal. In this case, the third low-level ECU 70 detects the depressing amount of the accelerator pedal by means of the sensor 90, and the first low-level ECU 50 commands the fuel injector or the ignition device serving as the actuator 80 as to a fuel injection amount or ignition timing based on the detected depressing amount of the accelerator pedal, etc. This allows the vehicle to travel in response to the driver accelerator pedal operation. Furthermore, if the drive source of the vehicle is not an internal combustion engine but an electric motor, the actuator 80 may be the electric motor. In other examples, the actuator 80 may be a shift actuator that switches over a shift range of the vehicle, and the sensor 90 may be a shift sensor that detects the user operation to a shift lever.

As described, as long as the actuator 80 and the sensor 90 are used for the user to get into the vehicle and/or to drive the vehicle, types of the actuator 80 and the sensor 90 do not matter. In the present embodiment, in the power-saving oriented mode, the supply of power to the actuator 80 and sensor 90, as well as to the first low-level ECU 50 which commands the operation of the actuator 80 and the third low-level ECU 70 to which the sensor signal from the sensor 90 is provided, can be stopped. This makes it extremely difficult for the vehicle to be stolen by a third party who does not have the authorized vehicle key (portable device 300 or electronic key). The vehicle system 200 may be applied to systems other than the smart-entry/smart-start system 100.

Next, the cluster, the NM message, the PNC configuration information, and PN request information will be described. In the present embodiment, in order to achieve the partial networking with NM messages, a respective first to third low-level ECU 50, 60, 70 is associated with one or more assigned clusters to which the respective first to third low-level ECU 50, 60, 70 belongs among multiple clusters being divisions. In the partial networking, ECUs belonging to certain one or more clusters among the multiple clusters are in the activated state (operational state), and ECUs belonging to the other clusters are in the powered off state or in the sleep state. By activating only the ECUs required to operate, it is possible to reduce the power consumption of ECUs mounted on the vehicle.

The PNC configuration information indicating the cluster assigned to a respective first to third low-level ECU 50, 60, 70 is stored and retained in a storage (not shown) of the respective first to third low-level ECU 50, 60, 70, and in a storage (not shown) of the corresponding first to third intermediate-level ECU 20, 30, 40. The PNC configuration information retained in a respective first to third intermediate-level ECU 20, 30, 40 is the same as that retained in the corresponding first to third low-level ECU 50, 60, 70. The PNC configuration information retained in the first to third intermediate-level ECU 20, 30, 40 is used to turn ON and OFF the first to third relay circuit 26, 36, 46 based on the NM message. Therefore, it can be said that the PNC configuration information retained in the first to third intermediate-level ECU 20, 30, 40 is configured for the first to third relay circuit 26, 36, 46.

In the case of the power-saving oriented mode, the first to third intermediate-level ECU 20, 30, 40 receives the NM message on behalf of the corresponding first to third low-level ECU 50, 60, 70 when the supply of power to the corresponding first to third low-level ECU 50, 60, 70 is cut off. Then, the first to third intermediate-level ECU 20, 30, 40 determines whether the received NM message contains the PN request information that designates the cluster to which the corresponding first to third low-level ECU 50, 60, 70 belong as the active cluster. When the first to third intermediate-level ECU 20, 30, 40 determines that the received NM message contains the PN request information designating the cluster to which the corresponding first to third low-level ECU 50, 60, 70 belongs as the active cluster, the first to third intermediate-level ECU 20, 30, 40 turns ON the corresponding first to third relay circuit 26, 36, 46 and starts the supply of power to the corresponding first to third low-level ECU 50, 60, 70. As a result, the first to third low-level ECU 50, 60, 70, to which the supply of power has been started, activates via a given boot process.

In the case of the responsiveness-oriented mode, the determination of whether there is a match between the active cluster contained in the PN request information of the received NM message and the cluster contained in the PNC configuration information for the corresponding first to third low-level ECU 50, 60, 70 is not executed by the first to third intermediate-level ECU 20, 30, 40 but is executed by the first to third low-level ECU 50, 60, 70. If a respective first to third low-level ECU 50, 60, 70 determines that the received NM message contains the PN request information that designates the cluster to which the respective first to third low-level ECU 50, 60, 70 belongs as the active cluster, the respective first to third low-level ECU 50, 60, 70 activates from the sleep state and enters into the operational state or keeps the operational state if already in the operational state. When an activation request absent state of the first to third low-level ECU 50, 60, 70 has lasted for a given period of time, the first to third low-level ECU 50, 60, 70 enters into the sleep state. The activation request absent state is a state in which it is determined by the first to third low-level ECU 50, 60, 70 that the PN request information that designates the cluster to which the respective first to third low-level ECU 50, 60, 70 belongs as the active cluster is not contained in the NM received message.

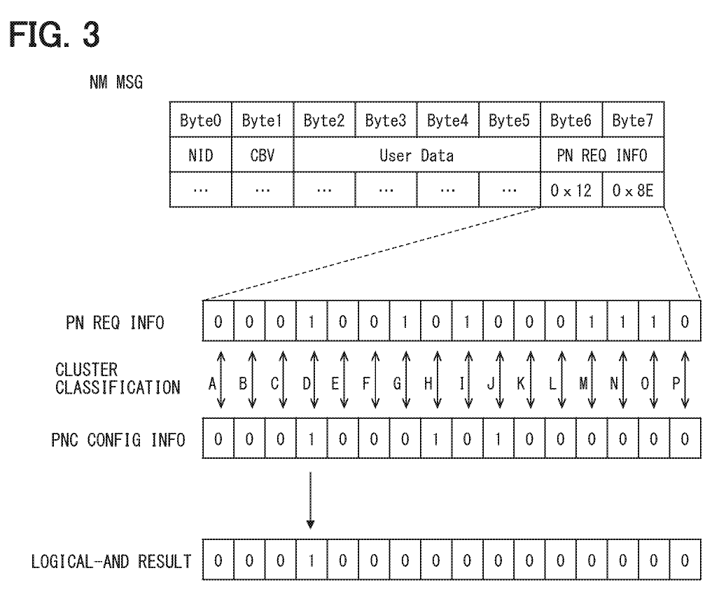

FIG. 3 shows an example of the NM message. In the example shown in FIG. 3, the NM message includes data of Byte 0 to Byte 7. Byte 0 contains a node ID (NID). The node ID is an identifier unique to each of the high-level ECU 10, the first to third intermediate-level ECUs 20, 30, 40, and the first to third low-level ECUs 50, 60, 70. The node ID enables to identify the transmission source of the NM message. Byte 1 contains a control bit vector (CBV). The control bit vector contains data indicating use or not-use of the partial networking. When the control bit vector indicates the use of the partial networking, the user data area of bytes 2 to 7 contains PN the request information indictive of the cluster to be active (also referred to as the active cluster).

In the example shown in FIG. 3, the control bit vector indicates the use of the partial networking, and the PN request information is stored in Byte 6 and Byte 7 of the user data area. The user data area of Byte 2 to Byte 5 is usable to convey any information such as an ECU activation factor or information on normality or abnormality, for example. It should be noted that FIG. 3 shows only one example of the format of the NM message. The NM message may be in another format as long as the NM message contains the PN request information. For example, NID and CBV may be omitted.

The PN request information indicates, for each of multiple clusters, whether the cluster is to be active or not required to be active. More specifically, in the example shown in FIG. 3, there are 16 clusters into which dividing was made in advance. The PN request information includes 16 bits data corresponding to the 16 clusters. The 16-bit data of the PN request information is associated with the 16 clusters in advance. When a bit of the 16 bits data in the PN request information is "0", it indicates that the associated cluster is not required to be active. When a bit of the 16 bits data in the PN request information is "1", it indicates that the associated cluster is required to be active. The PN request information may indicate only the cluster to be active (also referred to as the active cluster). Alternatively, the PN request information may indicate only the cluster not required to be active. Both of the PN request information indicating only the cluster to be active and the PN request information indicating only the cluster not required to be active is the PN request information explicitly or implicitly designating the cluster to be active. Both of the PN request information indicating only the cluster to be active and the PN request information indicating only the cluster not required to be active is the PN request information explicitly or implicitly designating the cluster not required to be active (also called a de-active cluster).

FIG. 3 also shows an example of the PNC configuration information configured for a respective first to third low-level ECU 50, 60, 70. In the PNC configuration information shown in FIG. 3, when the associated clusters are classified as A to P from the left to the right in FIG. 3, the PNC configuration information in FIG. 3 indicates that the first to third low-level ECU 50, 60, 70 for which this PNC configuration information is configured belongs to the clusters D, H and J. A respective first to third low-level ECU 50, 60, 70 may belong to one or more clusters because the respective first to third low-level ECU 50, 60, 70 may perform various functions by executing programs, for example.

The first to third intermediate-level ECUs 20, 30, 40, and the first to third low-level ECUs 50, 60, 70 may receive the NM messages containing the PN request information via their respective communication IFs 22, 32, 42, 52, 62, 72. Upon receiving an NM message, the first to third intermediate-level ECU 20, 30, 40 or the first to third low-level ECU 50, 60, 70 makes a bit-by-bit comparison between the PN request information in the NM message and the PNC configuration information for the corresponding low-level ECU or the PNC configuration information to calculate a logical AND, as shown in FIG. 3.

Then, based on the calculation result of the logical AND, the first to third intermediate-level ECU 20, 30, 40 or the first to third low-level ECU 50, 60, 70 determines whether there is a match between he cluster requested to be activated by the PN request information in the NM message and the cluster of the PNC configuration information of the first to third intermediate-level ECU 20, 30, 40 or the PNC configuration information for the corresponding low-level ECU. For example, in the example shown in FIG. 3, the clusters requested to be activated by the PN request information are clusters D, G, I, M, N, and O. The PNC configuration information indicates that the clusters to which the low-level ECU belongs are the clusters D, H, and J. In this case, at the cluster D, there is the match between the cluster requested to be activated by the PN request information of the NM message and the cluster in the PNC configuration information. Therefore, at the cluster D, the result of the logical AND is "1" as shown in FIG. 3.

In the case of the power-saving oriented mode, the first to third intermediate-level ECU 20, 30, 40 determines whether there is a match between the cluster requested to be activated by the PN request information in the NM message and the cluster in the PNC configuration information for the corresponding low-level ECU. When the logical AND results in “1” at any of (i.e., at any one of or at any ones of) the bits, the first to third intermediate-level ECU 20, 30, 40 determines that the low-level ECU for which the PNC configuration information shown in FIG. 3 is configured is requested to be activated. In response to this determination, the first to third intermediate-level ECU 20, 30, 40 turns ON the relay circuit corresponding to the low-level ECU for which the PNC configuration information shown in FIG. 3 is configured. When the relay circuit is already in the ON state, the first to third intermediate-level ECU 20, 30, 40 keeps the ON state of the relay circuit. On the other hand, when the logical AND results in “1” at none of the bits, i.e., results in “0” at all of the bits, the first to third intermediate-level ECU 20, 30, 40 determines that the low-level ECU for which the PNC configuration information shown in FIG. 3 is configured is not requested to be activated. If this determination result has lasted for a given period of time while the relay circuit is in the ON state, the first to third intermediate-level ECU 20, 30, 40 turns OFF the relay circuit corresponding to the low-level ECU for which the PNC configuration information shown in FIG. 3 is configured.

In the case of the responsiveness-oriented mode, a respective first to third low-level ECU 50, 60, 70 determines whether there is a match between the cluster requested to be activated by the PN request information in the NM message and the cluster in the PNC configuration information of the respective first to third low-level ECU 50, 60, 70. When the logical AND results in “1” at any of the bits, a respective first to third low-level ECU 50, 60, 70 determines that the respective first to third low-level ECU 50, 60, 70 is requested to be activated. In response to this determination, the first to third low-level ECU 50, 60, 70 activates from the sleep state and enters into the operational state. If already in the operational state, the first to third low-level ECU 50, 60, 70 keeps the operational state. On the other hand, when the logical AND results in “1” at none of the bits, i.e., results in “0” at all of the bits, the respective first to third low-level ECU 50, 60, 70 determines that the respective first to third low-level ECU 50, 60, 70 is not requested to be activated. If this determination result has lasted for a given period of time while in the operational state, the first to third low-level ECU 50, 60, 70 enters into the sleep state.

The PNC configuration information may be configured for the high-level ECU 10 and/or the first to third intermediate-level ECU 20, 30, 40 and may switch over between the activated state (operational state) and the sleep state based on the NM message. Alternatively, the high-level ECU 10 and/or the first to third intermediate-level ECU 20, 30, 40 may be configured to keep the operational state as long as receipt of the NM message from another ECU is present, and may be configured to enter into the sleep state upon elapse of a given period of time after the last receipt of the NM message from another ECU.

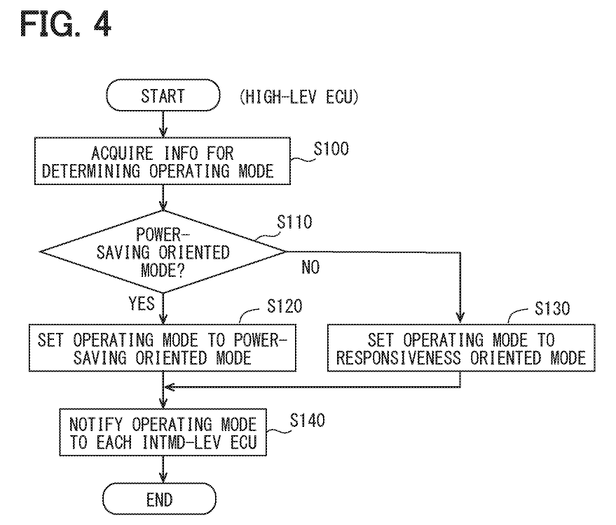

Next, an example of processes executed in the high-level ECU 10, the first to third intermediate-level ECU 20, 30, 40, and the first to third low-level ECU 50, 60, 70 will be described with reference to the flowcharts in FIGS. 4 - 6. Execution of the flowcharts described below by the high-level ECU 10, the first to third intermediate-level ECU 20, 30, 40, and the first to third low-level ECU 50, 60, 70 corresponds to execution of a control method of the vehicle system 200 in the present disclosure.

The flowchart of FIG. 4 will be described. FIG. 4 is a flowchart showing an example of a process executed by the high-level ECU 10 to determine the operating mode of the vehicle system 200. The high-level ECU 10 periodically executes the process shown in the flowchart of FIG. 4. However, if, for example, any of the first or third intermediate-level ECUs 20, 30, 40 also serves as the high-level ECU 10, the process shown in the flowchart in FIG. 4 may be executed by any of the first or third intermediate-level ECUs 20, 30, 40 serving as the high-level ECU 10.

In step S100, the high-level ECU 10 acquires information for determining the operating mode of the vehicle system 200. For example, as the information for determining the operating mode, the high-level ECU 10 may receive the command as to the selection of the operating mode of the vehicle system 200 from the portable device 300 via the TCU 16 communicable with the cloud server 400. Alternatively, the high-level ECU 10 may receive the command as to the selection of the operating mode of the vehicle system 200 via the second low-level ECU 60 able to detect the touch operation onto the multimedia screen. In addition, as the information for determining the operating mode, the high-level ECU 10 may acquire information on whether or not the user is present in or around the vehicle and/or acquire information on the area where the vehicle is parked.

In step S110, the high-level ECU 10 determines whether the operating mode of the vehicle system 200 should be the power saving oriented mode or the responsiveness-oriented mode based on the information acquired in step S100. For example, if the high-level ECU 10 receives the command to set the operating mode to the power-saving oriented mode, or if the high-level ECU 10 determines, based on the situation of the vehicle, that the operating mode of the vehicle system 200 should be the power-saving oriented mode, the high-level ECU 10 determines to set the vehicle system 200 to the power-saving oriented mode. On the other hand, if the high-level ECU 10 receives the command to set the operating mode to the responsiveness-oriented mode, or if the high-level ECU 10 determines based on the situation of the vehicle that the operating mode of the vehicle system 200 should not be the power-saving oriented mode, the high-level ECU 10 determines to set the vehicle system 200 to the responsiveness-oriented mode. If the high-level ECU 10 determines to set the operating mode to the power-saving-oriented mode, the high-level ECU 10 proceeds to step S120. On the other hand, if the high-level ECU 10 determines to set the operating mode to the responsiveness-oriented mode, the high-level ECU 10 proceeds to step S130.

In step S120, the high-level ECU 10 sets the operating mode of the vehicle system 200 to the power-saving oriented mode. On the other hand, in step S130, the high-level ECU 10 sets the operating mode of the vehicle system 200 to the responsiveness-oriented mode. Then, the high-level ECU 10 proceeds to S140. In step S140, the high-level ECU 10 notifies the operating mode set in step S120 or S130 to the first to third intermediate-level ECUs 20, 30, 40. This allows the first to third intermediate-level ECUs 20, 30, 40 to ascertain the operating mode of the vehicle system 200.

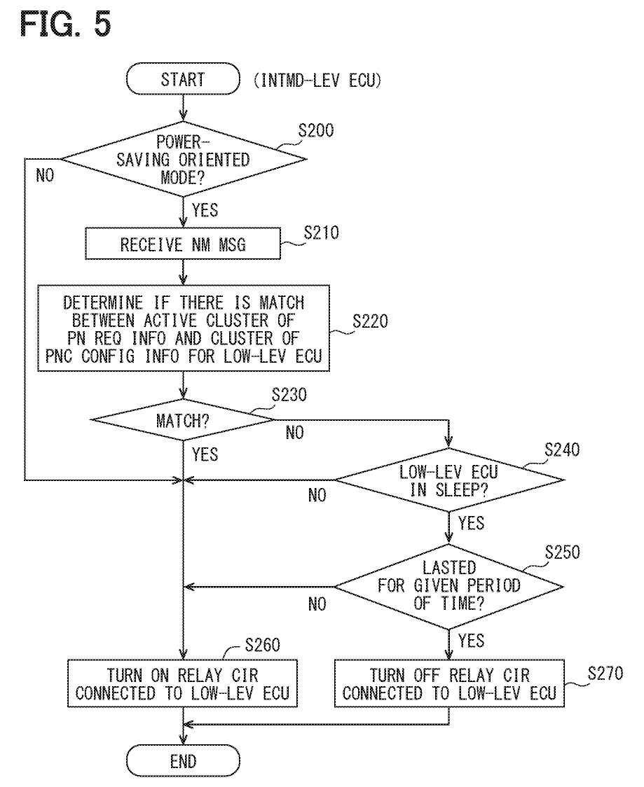

The flowchart of FIG. 5 will be described. FIG. 5 is a flowchart showing an example of the process executed by the first to third intermediate-level ECU 20, 30, 40 to turn ON and OFF the first to third relay circuit 26, 36, 46 based on the received NM message when the operating mode of the vehicle system 200 is the power-saving oriented mode. The first to third intermediate-level ECUs 20, 30, 40 periodically execute the process shown in the flowchart in FIG. 5. In the following, an example in which the first intermediate-level ECU 20 executes the process shown in the flowchart in FIG. 5 will be described.

In step S200, the first intermediate-level ECU 20 determines whether the operating mode of the vehicle system 200 is the power-saving oriented mode. If it is determined that the operating mode of the vehicle system 200 is the power-saving oriented mode, the first intermediate-level ECU 20 proceeds to step S210. On the other hand, if it is determined that the operating mode of the vehicle system 200 is the responsiveness-oriented mode, the first intermediate-level ECU 20 proceeds to step S260.

In step S210, the first intermediate-level ECU 20 receives the NM message. When the NM message is received, the first intermediate-level ECU 20 determines in step S220 whether there is a match between the active cluster contained in the PN request information of the received NM message and the cluster contained in the PNC configuration information for the corresponding first low-level ECU 50.

In step S230, the first intermediate-level ECU 20 determines whether the match between the active cluster contained in the PN request information of the NM message and the cluster contained in the PNC configuration information for the corresponding first low-level ECU 50 has been determined in step S220. If the match has been determined, the first intermediate-level ECU 20 proceeds to step S260. On the other hand, if the match has not been determined, the first intermediate-level ECU 20 proceeds to step S240. If the receipt of the NM message is absent in step S210, the first intermediate-level ECU 20 determines in step S230 that the match has not been determined.

In step S240, the first intermediate-level ECU 20 determines whether or not the first low-level ECU 50 is in the sleep mode. For example, the determination of whether or not the first low-level ECU 50 is in the sleep mode may be made in the following way. If the first intermediate-level ECU 20 transmits an inquiry signal to the first low-level ECU 50 but does not receive a response signal responding to the inquiry signal, the first intermediate-level ECU 20 may determine that the first low-level ECU 50 is in the sleep mode. Conversely, if the first medium ECU 20 receives the response signal, the first medium ECU 20 may determine that the first low-level ECU 50 is not in the sleep mode.

If the first low-level ECU 50 is not in the sleep state, there is a possibility that the first low-level ECU 50 is executing a process, e.g., a data storage process. If the supply of power to the first low-level ECU 50 stops while the first low-level ECU 50 is executing a process, the process being executed by the first low-level ECU 50 may be troubled. Therefore, if it is determined in step S240 that the first low-level ECU 50 is not in the sleep mode, the first intermediate-level ECU 20 proceeds to step S260. On the other hand, if it is determined that the first low-level ECU 50 is in the sleep mode, the first intermediate-level ECU 20 proceeds to step S250.

In step S250, the first intermediate-level ECU 20 determines whether or not a cluster un-match situation has lasted for a given period of time, wherein the cluster un-match situation is a situation where it has not been determined in step 220 that there is the match between the active cluster contained in the PN request information of the NM message and the cluster contained in the PNC configuration information for the corresponding first low-level ECU 50. If it is determined that the cluster un-match situation has lasted for the given period of time, the first intermediate-level ECU 20 proceeds to step S270. On the other hand, if it is determined that the cluster un-match situation has not lasted for the given period of time, the first intermediate-level ECU 20 proceeds to step S260.

In step S260, the first intermediate-level ECU 20 turns ON or keeps ON the first relay circuit 26 connected to the first low-level ECU 50. As a result, when it is determined that the operating mode of the vehicle system 200 is the responsiveness-oriented mode, the first relay circuit 26 is kept at the ON state. Also, in the case of the power-saving oriented, if the active cluster contained in the PN request information of the NM message matches the cluster contained in the PNC configuration information for the corresponding first low-level ECU 50, the first relay circuit 26 is kept at the ON state. Furthermore, where (i) the vehicle system 200 is in the power-saving oriented and (ii) the active cluster contained in the PN request information of the NM message does not match the cluster contained in the PNC configuration information for the corresponding first low-level ECU 50, if (a) the first low-level ECU 50 is in the operational state or (b) the cluster- un-match situation has not lasted for the given period of time, the first relay circuit 26 is kept at the ON state.

In step S270, the first intermediate-level ECU 20 turns OFF the first relay circuit 26 connected to the first low-level ECU 50. Accordingly, it is possible to achieve the following operational effect. In the case of the power-saving oriented mode, where the first low-level ECU 50 is in the sleep state, it is possible to stop the supply of power to the first low-level ECU 50 if the cluster un-match situation has lasted for the given period of time, in other words, if the operation of the first low-level ECU 50 is stoppable, wherein the cluster un-match situation is the situation of the un-match between the active cluster contained in the PN request information of the NM message and the cluster contained in the PNC configuration information for the corresponding first low-level ECU 50.

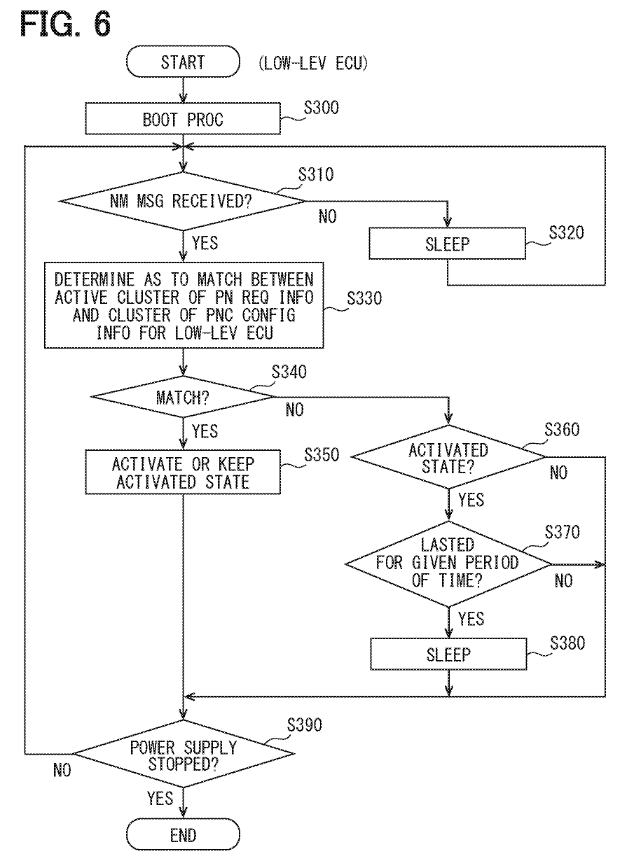

The flowchart of FIG. 6 will be described. FIG. 6 is a flowchart showing an example of a process executed by the first to third low-level ECU 50, 60, 70. A respective first to third low-level ECU 50, 60, 70 starts the process shown in the flowchart in FIG. 6 in response to the start of the supply of power to the respective first to third low-level ECU 50, 60, 70. In the following, an example will be described in which the process shown in the flowchart in FIG. 6 is executed by the first low-level ECU 50.

In step S300, in response to the start of the supply of power, the first low-level ECU 50 executes the boot process, such as reading a program stored in a nonvolatile storage medium and deploying it to a volatile main memory. After completing the boot process in step S300, the first low-level ECU 50 determines in step S310 whether or not the NM message has been received. Upon determining that the NM message has been received, the first low-level ECU 50 proceeds to step S330. On the other hand, if it is determined that the NM message has not been received, the first low-level ECU 50 proceeds to step S320.

In step S320, the first low-level ECU 50 enters into the sleep state. The first low-level ECU 50 then returns to step S310. In other words, until the first low-level ECU 50 receives the NM message that designates the cluster to which the first low-level ECU 50 belongs as the active cluster, the first low-level ECU 50 is in the sleep state.

In step S330, the first low-level ECU 50 determines whether or not there is a match between the active cluster contained in the PN request information of the received NM message and the cluster contained in the PNC configuration information thereof (i.e., the PNC configuration information of the first low-level ECU 50). In step S340, the first low-level ECU 50 determines whether or not the match between the active cluster contained in the PN request information of the received NM message and the cluster contained in the PNC configuration information thereof has been determined in step S330. If the match has been determined, the first low-level ECU 50 proceeds to step S350. On the other hand, if the match has not been determined, the first low-level ECU 50 proceeds to step S360.

In step S350, the first low-level ECU 50 activates from the sleep state and enters into the activated state. If already in the activated state, the first low-level ECU 50 keeps the activated state. In this activated state, the first low-level ECU 50 is able to execute such a process as driving the actuator 80.

In step S360, the first low-level ECU 50 determines whether or not the first low-level ECU 50 is in the activated state. If it is determined that the first low-level ECU 50 is in the activated state, the first low-level ECU 50 proceeds to step S370. On the other hand, if it is determined that the first low-level ECU 50 is not in the activated state, i.e., is in the sleep state, the first low-level ECU 50 proceeds to step S390.

In step S370, the first low-level ECU 50 determines whether or not the cluster un-match situation has lasted for the given period of time, wherein the cluster un-match situation is a situation where it has not been determined in S330 that there is the match between the active cluster contained in the PN request information of the NM message and the cluster contained in the PNC configuration information thereof. If it is determined that the cluster un-match situation has lasted for the given period of time, the first low-level ECU 50 proceeds to step S380. On the other hand, if it is determined that the cluster un-match situation has not lasted for the given period of time, the first low-level ECU 50 proceeds to step S390.

In step S380, the first low-level ECU 50 transitions from the activated state to the sleep state. Accordingly, it is possible to achieve the following operational effect. In the responsiveness-oriented mode, if the cluster un-match situation has lasted for the given period of time, in other words, if the operation of the first low-level ECU 50 is stoppable, it is possible to transition the first low-level ECU 50 into the sleep state. Therefore, in the responsiveness-oriented mode, because the first low-level ECU 50 activates from the sleep state in response to the command to activate by the NM message, it is possible to shorten the activation time of the first low-level ECU.

In step S390, the first low-level ECU 50 determines whether or not the supply of power via the first relay circuit 26 has stopped. If it is determined that the supply of power has been stopped, the first low-level ECU 50 ends the process shown in the flowchart in FIG. 6. On the other hand, if it is determined that the supply of power has not been stopped, the first low-level ECU 50 returns to step S310.

### Second Embodiment

Next, a vehicle system 200 according to a second embodiment of the present disclosure will be described. The vehicle system 200 according to the present embodiment includes the same configuration to the vehicle system 200 according to the first embodiment, the redundant description of such configuration be omitted.

In the vehicle system 200 of the first embodiment, the PNC configuration information retained in the first to third intermediate-level ECU 20, 30, 40 and the PNC configuration information retained in the first to third low-level ECU 50, 60, 70 are the same PNC configuration information as the PNC configuration information for the first to third low-level ECU 50, 60, 70. The PNC configuration information retained in the first to third intermediate-level ECU 20, 30, 40 and the first to third low-level ECU 50, 60, 70 are unchanged and fixed.

In contrast, in the vehicle system 200 of the present embodiment, in response to turn ON of the first to third relay circuit 26, 36, 46, the PNC configuration information for the first to third low-level ECU 50, 60, 70 (in other words, the first to third relay circuit 26, 36, 46) retained in the first to third intermediate-level ECU 20, 30, 40 is changed so that the changed PNC configuration information for the first to third low-level ECU 50, 60, 70 differs from the PNC configuration information retained in the first to third low-level ECU 50, 60, 70. Because of this, it is possible to make a difference between (i) the PNC configuration information for the first and third low-level ECU 50, 60, 70 to make the determination as to the switchover between the sleep state and the activated state and (ii) the PNC configuration information for the first and third intermediate-level ECU 20, 30, 40 to determine whether to turn OFF the first to third relay circuit 26, 36, 46. As a result, for example, it is possible to prevent the first to third intermediate-level ECU 20, 30, 40 from wrongly turning OFF the first to third relay circuit 26, 36, 46.

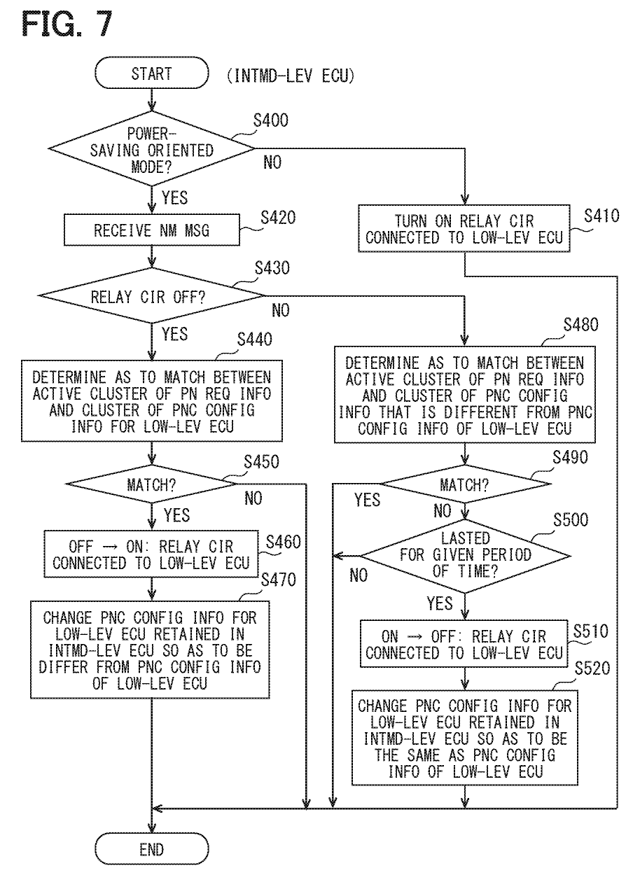

FIG. 7 is a flowchart showing an example of a process executed by the first to third intermediate-level ECU 20, 30, 40 in the vehicle system 200. The first to third intermediate-level ECU 20, 30, 40 periodically execute the process shown in the flowchart in FIG. 7. In the following, an example will be described in which the first intermediate-level ECU 20 executes the process shown in the flowchart in FIG. 7. In the flowchart in FIG. 7, the process corresponding to step S240 of the flowchart in FIG. 5 is omitted.

In step S400, the first intermediate-level ECU 20 determines whether or not the operating mode of the vehicle system 200 is the power-saving oriented mode. If it is determined that the operating mode of the vehicle system 200 is the power-saving oriented mode, the first intermediate-level ECU 20 proceeds to step S420. On the other hand, if it is determined that the operating mode of the vehicle system 200 is the responsiveness-oriented mode, the first intermediate-level ECU 20 proceeds to step S410.

In step S410, the first intermediate-level ECU 20 turns ON or keeps the ON state of the first relay circuit 26 connected to the first low-level ECU 50. As a result, when it is determined that the operating mode of the vehicle system 200 is the responsiveness-oriented mode, the first relay circuit 26 is maintained to have the ON state.

In step S420, the first intermediate-level ECU 20 receives the NM message. In step S430, the first intermediate-level ECU 20 determines whether or not the first relay circuit 26 connected to the first low-level ECU 50 is in the OFF state. If it is determined that the first relay circuit 26 is in the OFF state, the first intermediate-level ECU 20 proceeds to step S440. On the other hand, if it is determined that the first relay circuit 26 is in the ON state, the first intermediate-level ECU 20 proceeds to step S480.

In step S440, the first intermediate-level ECU 20 determines whether there is a match between the active cluster contained in the PN request information of the NM message received in step S420 and the cluster contained in the PNC configuration information for the first low-level ECU 50. Specifically, for turning ON the first relay circuit 26, the first intermediate-level ECU 20 makes the determination as to the match with the active cluster contained in the PN request information of the NM message by using the PNC configuration information configured for the first low-level ECU 50. Because of this, transmission of the NM message for activating the first low-level ECU 50 from another ECU alone makes it possible to turn ON the relay circuit 26 connected to the first low-level ECU 50.

In step S450, the first intermediate-level ECU 20 determines whether or not the match between the active cluster contained in the PN request information of the NM message and the cluster contained in the PNC configuration information for the first low-level ECU 50 has been determined in step S440. If the match has been determined, the first intermediate-level ECU 20 proceeds to step S460. On the other hand, if the match has not been determined, the first intermediate-level ECU 20 ends the process shown in the flowchart in FIG. 7. In this case, the first relay circuit 26 remains OFF.

In step S460, the first intermediate-level ECU 20 switches over the first relay circuit 26 connected to the first low-level ECU 50 from the OFF state to the ON state. As a result, where the operating mode of the vehicle system 200 is the power-saving oriented mode, if the active cluster contained in the PN request information of the NM message matches the cluster contained in the PNC configuration information for the first low-level ECU 50, the first relay circuit 26 is turned ON.

In step S470, the first intermediate-level ECU 20 changes the PNC configuration information for the first low-level ECU 50 (first relay circuit 26) retained in the first intermediate-level ECU 20 so that the changed PNC configuration information differs from the PNC configuration information retained in the first low-level ECU 50. Because of this, for switching over the first relay circuit 26 from the ON state to the OFF state, the first intermediate-level ECU 20 can make the determination as to the match with the active cluster contained in the PN request information of the NM message by using the PNC configuration information different than the PNC configuration information configured for (and retained in) the first low-level ECU 50.

In step S480, the first intermediate-level ECU 20 determines whether there is a match between the active cluster contained in the PN request information of the NM message received in step S420 and the cluster contained in the PNC configuration information different than the PNC configuration information of first low-level ECU 50. In step S490, the first intermediate-level ECU 20 determines whether or not it has been determined in step S480 that there is the match between the active cluster contained in the PN request information of the NM message received in step S420 and the cluster contained in the PNC configuration information different than the PNC configuration information of the first low-level ECU 50. If the match has been determined, the first intermediate-level ECU 20 proceeds to step S500. On the other hand, if the match has not been determined, the first intermediate-level ECU 20 ends the process shown in the flowchart in FIG. 7. In this case, the first relay circuit 26 remains ON.

In step S500, the first intermediate-level ECU 20 determines whether or not the cluster un-match situation has lasted for the given period of time, wherein the cluster un-match situation is a situation where it has not determined that there is the match between the active cluster contained in the PN request information of the NM message and the cluster contained in the PNC configuration information different from the PNC configuration information of the first low-level ECU 50. If it is determined that the cluster un-match situation has lasted for the given period of time, the first intermediate-level ECU 20 proceeds to step S510. On the other hand, if it is determined that the cluster un-match situation has not lasted for the given period of time, the first intermediate-level ECU 20 ends the process shown in the flowchart in FIG. 7.

In step S510, the first intermediate-level ECU 20 switches over the first relay circuit 26 connected to the first low-level ECU 50 from the ON state to the OFF state. Because of this, where the operating mode of the vehicle system 200 is the power-saving oriented mode, if the cluster un-match situation has lasted for the given period of time, the first relay circuit 26 is turned OFF, wherein the cluster un-match situation a situation the match between the active cluster contained in the PN request information of the NM message and the cluster contained in the PNC configuration information different than the PNC configuration information configured for the first low-level ECU 50 is absent.

In step S520, the first intermediate-level ECU 20 changes the PNC configuration information for the first low-level ECU 50 (first relay circuit 26) retained in the first intermediate-level ECU 20 so that the changed PNC configuration information is the same as the PNC configuration information retained in the first low-level ECU 50. Because of this, for switching over the first relay circuit 26 from the OFF state to the ON state, the first intermediate-level ECU 20 can determine the match with the active cluster contained in the PN request information of the NM message by using the PNC configuration information configured for the first low-level ECU 50.

### Third Embodiment

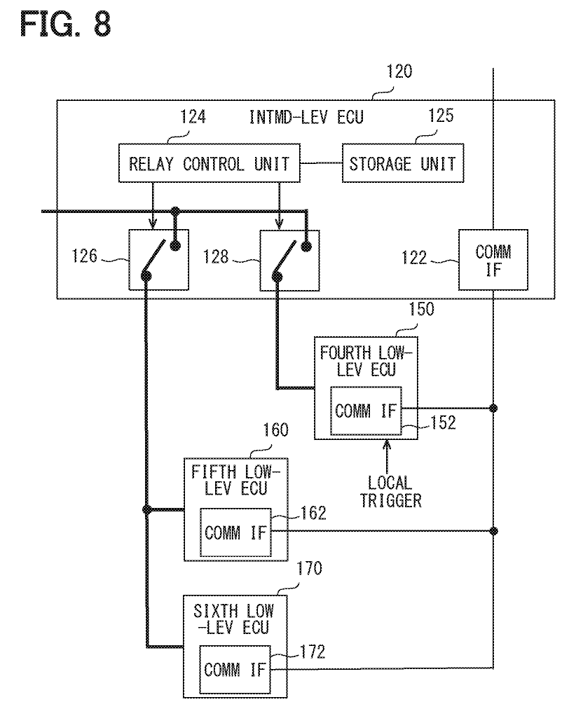

Next, a third embodiment of the present disclosure will be described. The first and second embodiments described above show that each one of the first to third relay controllers 24, 34, 44 of the first to third intermediate-level ECUs 20, 30, 40 controls ON and OFF of one relay circuit 26, 36, 46, by way of example. However, as shown in FIG. 8, at least one relay controller 124 may be configured to control the on and off of multiple relay circuits 126, 128.

In the example shown in FIG. 8, a fifth low-level ECU 160 and a sixth low-level ECU 170 are connected to the relay circuit 126. A fourth low-level ECU 150 is connected to the relay circuit 128. The fourth to sixth low-level ECUs 150, 160, 170 include communication IFs 152, 162, 172, respectively. The communication IFs 152, 162, 172 are connected to a communication IF 122 of the intermediate-level ECU 120 via a communication bus.

When the relay controller 124 is configured to control turn ON and OFF of the multiple relay circuits 126, 128, the intermediate-level ECU 120 includes a storage 125 storing (i) PNC configuration information for the fourth to sixth low-level ECUs 150, 160, 170 connected to the plurality of relay circuits 126, 128 and (ii) connection information on connection between the fourth to sixth low-level ECUs 150, 160, 170 and the multiple relay circuits 126, 128,

In the power-saving oriented mode, when the intermediate-level ECU 120 receives the NM message, the intermediate-level ECU 120 determines, based on the PNC configuration information for the fourth to sixth low-level ECUs stored in the storage 125, whether or not there is a match between the active cluster of the PN request information in the NM message and the cluster of the PNC configuration information for the fourth to sixth low-level ECUs 150, 160, 170. When the intermediate-level ECU 120 determines that the active cluster of the PN request information in the NM message matches one or more of the clusters in the PNC configuration information for the fourth to sixth low-level ECUs 150, 160, 170, the intermediate-level ECU 120 refers to the connection information in the storage 125 and specifies and turns ON one or more of the relay circuits corresponding to one or more low-level ECUs requested to be activated. This makes it possible to supply power to the low-level ECU requested to be activated by the NM message.

In the example shown in FIG. 8, the relay circuit 126 is connected to the fifth low-level ECU 160 and the sixth low-level ECU 170. The relay circuit 128 is connected to the fourth low-level ECU 150. Therefore, when the intermediate-level ECU 120 determines that the active cluster of the PN request information in the NM message matches the cluster of the PNC configuration information for the fifth low-level ECU 160 or the sixth low-level ECU 170, the intermediate-level ECU 120 turns ON the relay circuit 126. When the intermediate-level ECU 120 determines that the active cluster of the PN request information in the NM message matches the cluster of the PNC configuration information for the fourth low-level ECU 150, the intermediate-level ECU 120 turns ON the relay circuit 128.

FIG. 8 also shows an example in which the fourth low-level ECU 150 is activated from the sleep state by a local trigger signal and enters into the operational state. The local trigger signal is, for example, generated when the user of the vehicle performs a predetermined operation. The local trigger signal is input to the low-level ECU required to operate due to the predetermined operation. Therefore, in the example shown in FIG. 8, the fourth low-level ECU 150 is required to be activated from the sleep state in response to the generation of the local trigger signal. In this regard, however, where the fourth low-level ECU 150 is activated by the local trigger signal, the power may be supplied also to another low-level ECU not required to operate, and the dark current may flow needlessly.

Therefore, when the multiple low-level ECUs 150, 160, 170 connected to the multiple relay circuits 126, 128 include the low-level ECU 150 configured to be activated in response to the local trigger signal, it may be preferable that the low-level ECU 150 configured to be activated in response to the local trigger signal and the low-level ECU 160, 170 not configured to be activated in response to the local trigger signal are connected to different (separate) relay circuits 126, 128. This allows only the low-level ECU 150 to be activated in response to the local trigger signal and prevents an increase in power consumption due to the dark current described above.

It may be preferable that the fourth low-level ECU 150 is able to be activated from the sleep mode whenever the local trigger signal occurs. Therefore, it is conceivable that the intermediate-level ECU 120 is configured to, in principle, cause the relay circuit 128 connected to the fourth low-level ECU 150 to be in the ON state when there is a possibility that the local trigger signal occurs. On the other hand, because the fifth low-level ECU 160 and the sixth low-level ECU 170 connected to the relay circuit 126 need not to be activated in response to the local trigger signal, an ON period of the relay circuit 126 may be shorter than an ON period of the relay circuit 128. Therefore, the timing of turn ON or OFF of the relay circuit 128 connected to the fourth low-level ECU 150 configured to be activated in response to the local trigger signal may be different from the timing of turn ON or OFF of the relay circuit 126 connected to the fifth low-level ECU 160 and the sixth low-level ECU170 each not configured to be activated in response to the local trigger signal.

### MODIFICATIONS

Although embodiments of the present disclosure have been described above, the present disclosure is not limited to the above-described embodiments, various modifications can be made without departing from the spirit and scope of the present disclosure.

### First Modification

The first embodiment describes an example in which each of the first to third intermediate-level ECU 20, 30, 40 and the first to third low-level ECU 50, 60, 70 has the same PNC configuration information as the PNC configuration information for the first to third low-level ECU 50, 60, 70.

However, the PNC configuration information for the first to third low-level ECU 50, 60, 70 retained in the first to third intermediate level ECUs 20, 30, 40 may be different from the PNC configuration information retained in the first to third low-level ECU 50, 60, 70. In this case, the PNC configuration information for the first to third low-level ECU 50, 60, 70 retained in the first to third intermediate-level ECU 20, 30, 40 may be rephrased as the PNC configuration information configured for the first to third relay circuit 26, 36, 46.

The PNC configuration information configured for the first to third relay circuit 26, 36, 46 and retained in the first to third intermediate-level ECU 20, 30, 40 and the PNC configuration information retained in the first to third low-level ECU 50, 60, 70 may be unchanged and fixed.

### Second Modification

The systems, methods, and electronic control units of the present disclosure may be implemented by a dedicated computer provided by configuring a processor programmed to perform one or more functions embodied by a computer program. The systems, methods, and electronic control units of the present disclosure may be implemented by dedicated hardware logic circuits. The systems, methods, electronic control units of the present disclosure may be implemented by one or more dedicated computers provided by configuring a processor that executes a computer program in combination with one or more hardware logic circuits. For example, part or all of the functions of the high-level ECU 10, the first to third intermediate-level ECU 20, 30, 40, and the first to third low-level ECU 50, 60, 70 may be implemented by hardware. Example of a form of implementing a certain function by hardware include implementing by using one or more ICs or the like. Part or all of the functions of the high-level ECU 10, the first to third intermediate-level ECU 20, 30, 40, and the first to third low-level ECU 50, 60, 70 may be implemented by using a system-on-chip (SoC), integrated circuit (IC) and/or a field programmable gate array (FPGA). The term “IC” encompasses ASIC (Application Specific Integrated Circuits). The computer program may be stored in a computer-readable non-transitory tangible storage medium as instructions to be executed by a computer. Examples of the storage medium for the computer program include a hard disk drive (i.e., HDD), a solid-state drive (i.e., SSD), a flash memory, and the like. The present disclosure encompasses a program causing a computer to function as the high-level ECU 10, the first to third intermediate-level ECU 20, 30, 40, and the first to third low-level ECU 50, 60, 70, and a non-transitory tangible storage medium storing thereon the program such as a semiconductor memory, etc.

What is claimed is:

1. A vehicle system comprising
a plurality of control devices mounted on a vehicle, wherein:
the plurality of control devices is each implemented at least by a processor that executes a program and/or a dedicated hardware circuit;
the plurality of control devices includes a low-level control device being at least one low-level control device and a high-level side control device being at least one high-level side control device;
the high-level side control device includes a relay controller that turns ON and OFF a relay circuit provided in a power supply line for the low-level control device;
the low-level control device retains cluster configuration information indicative of a cluster to which the low-level control device belongs among a plurality of clusters being divisions and switches over between a sleep state and an activated state depending on presence and absence of receipt of a network management message that designates the cluster to which the low-level control device belongs as an active cluster;
a control device being any of the plurality of control devices determines whether an operating mode of the vehicle system is a power-saving oriented mode in which emphasis is placed on power saving of the vehicle system or a responsiveness-oriented mode in which emphasis is placed on responsiveness of processing of the vehicle system;
where the control device determines that the operating mode of the vehicle system is the power-saving oriented mode, if the low-level control device is to stop operating, the relay controller of the high-level side control device turns OFF the relay circuit and stops supply of power to the low-level control device; and
where the control device determines that the operating mode of the vehicle system is the responsiveness-oriented mode, if the low-level control device is to stop operating, the relay controller of the high-level side control device keeps an ON state of the relay circuit to enable the low-level control device to switch over to the sleep state based on the network management message.

2. The vehicle system according to claim 1, wherein:
where the operating mode of the vehicle system is the power-saving oriented mode, if the low-level control device is to be activated, the relay controller of the high-level side control device turns ON the relay circuit so that, in response to the relay circuit switching over from an OFF state to the ON state and starting the supply of power to the low-level control device, the low-level control device activates.

3. The vehicle system according to claim 2, wherein:
after the low-level control device activates in response to start of the supply of power to the low-level control device, the low-level control device enters into the sleep state if the receipt of the network management message that designates the cluster to which the low-level control device belongs as the active cluster is absent.

4. The vehicle system according to claim 1, wherein:
when the power-saving oriented mode is commanded by a user of the vehicle, the control device being any of the plurality of control devices determines that the operating mode of the vehicle system is the power-saving oriented mode.

5. The vehicle system according to claim 1, wherein:
when the control device being any of the plurality of control devices determines that the vehicle system is in a situation where it is considered that the vehicle system is unlikely used, the control device determines that the operating mode of the vehicle system is the power-saving oriented mode.

6. The vehicle system according to claim 5, wherein:
the situation where it is considered that the vehicle system is unlikely used is a situation where a period of time during which a user is absent in or around the vehicle reaches a given period of time or more.

7. The vehicle system according to claim 5, wherein:
the situation where it is considered that the vehicle system is unlikely used is a situation where the vehicle is parked in a given area.

8. The vehicle system according to claim 1, wherein:
where the operating mode of the vehicle system is the power-saving oriented mode, if the low-level control device is to stop operating, the relay controller of the high-level side control device turns OFF the relay circuit on condition that the low-level control device is in the sleep state.

9. The vehicle system according to claim 1, wherein:
the cluster is configured for the relay circuit; and
where the operating mode of the vehicle system is the power-saving oriented mode, the relay controller of the high-level side control device turns OFF the relay circuit in response to the receipt of the network management message that designates the cluster configured for the relay circuit as a de-active cluster.

10. The vehicle system according to claim 9, wherein:
the cluster configured for the relay circuit and the cluster to which the low-level control device belongs are a same cluster.

11. The vehicle system according to claim 9, wherein:
the cluster configured for the relay circuit and the cluster to which the low-level control device belongs are different clusters.

12. The vehicle system according to claim 1, wherein:
the high-level side control device changes cluster configuration information corresponding to the low-level control device to which the supply of power has been started in response to turn ON of the relay circuit so that a cluster different from the cluster to which the low-level control device belongs is belonged to.

13. The vehicle system according to claim 1, wherein:
the relay controller turns ON or OFF a plurality of the relay circuits respectively provided in a plurality of the power supply lines for a plurality of the low-level control devices;
the high-level side control device includes a storage in which cluster configuration information indicative of clusters to which the plurality of low-level control devices belongs and connection information on connection between the plurality of low-level control devices and the plurality of relay circuits are stored; and
in response to receipt of the network management message that designates the cluster to which any of the plurality of low-level control devices belongs as the active cluster, the high-level side control device refers to the connection information and turns ON the relay circuit that corresponds to the low-level control device requested to be activated.

14. The vehicle system according to claim 1, wherein:
the plurality of control devices includes a plurality of the low-level control devices;
at least one low-level control device among the plurality of low-level control devices is configured to be activated in response to a local trigger signal; and
the low-level control device configured to be activated in response to the local trigger signal and the low-level control device not configured to be activated in response to the local trigger signal are connected to the relay circuits that are separate.

15. The vehicle system according to claim 14, wherein:
timing of turn ON or OFF of the relay circuit to which the low-level control device configured to be activated in response to the local trigger signal is connected is different from timing of turn ON or OFF of the relay circuit to which the low-level control device not configured to be activated in response to the local trigger signal is connected.

16. A control method of a vehicle system, wherein:
the vehicle system includes a plurality of control devices mounted on a vehicle;
the plurality of control devices includes a low-level control device being at least one low-level control device and a high-level side control device being at least one high-level side control device;
the high-level side control device includes a relay controller that turns ON or OFF a relay circuit provided in a power supply line for the low-level control device; and
the low-level control device retains cluster configuration information indicative of a cluster to which the low-level control device belongs among a plurality of clusters being divisions and switches over between a sleep state and an active state depending on presence and absence of receipt of a network management message that designates the cluster to which the low-level control device belongs as an active cluster,
the control method comprising:
by a control device being any of the plurality of control device, determining whether an operating mode of the vehicle system is a power-saving oriented mode in which emphasis is placed on power saving of the vehicle system or a responsiveness-oriented mode in which emphasis is placed on responsiveness of processing of the vehicle system;
where the control device determines that the operating mode of the vehicle system is the power-saving oriented mode, if the low-level control device is to stop operating, by the relay controller of the high-level side control device, turning OFF the relay circuit and stopping supply of power to the low-level control device; and
where the control device determines that the operating mode of the vehicle system is the responsiveness-oriented mode, if the low-level control device is to stop operating, by the relay controller of the high-level side control device, keeping an ON state of the relay circuit to enable the low-level control device to switch over to the sleep state based on the network management message.

17. An electronic control unit that is in a vehicle system including a low-level control device being at least one low-level control device and a high-level side control device being at least one high-level side control device and that is used as the high-level side control device, wherein:
the low-level control device and the high-level side control device are each implemented at least by a processor that executes a program and/or a dedicated hardware circuit;
the low-level control device retains cluster configuration information indicative of a cluster to which the low-level control device belongs among a plurality of clusters being divisions and switches over between a sleep state and an active state depending on presence and absence of receipt of a network management message that designates the cluster to which the low-level control device belongs as an active cluster; and
the vehicle system has a power-saving oriented mode and a responsiveness-oriented mode as an operating mode thereof,
the high-level side control device comprising
a relay controller that turns ON and OFF a relay circuit provided in a power supply line for the low-level control device,
wherein:
where the operating mode of the vehicle system is the power-saving oriented mode, if the low-level control device is to stop operating, the relay controller of the high-level side control device turns OFF the relay circuit and stops supply of power to the low-level control device; and
where the operating mode of the vehicle system is the responsiveness-oriented mode, if the low-level control device is to stop operating, the relay controller of the high-level side control device keeps an ON state of the relay circuit to enable the low-level control device to switch over to the sleep state based on the network management message.
